(19) United States
(12) Patent Application Publication
(10) Pub. No.: US 2009/0006456 A1
(43) Pub. Date: Jan. 1, 2009

(54) CHARACTERIZING RUN-TIME PROPERTIES OF COMPUTING SYSTEM

(75) Inventors: Mika HONGISTO, Oulu (FI); Anton YRJONEN, Oulu (FI); Kari KOLEHMAINEN, Oulu (FI)

Correspondence Address: Young & Thompson, Second Floor, 745 S. 23rd Street, Arlington, VA, 22202, US

(73) Assignee: VALTION TEKNILLINEN TUTKIMUSKESKUS, Espoo (FI)

(21) Appl. No.: 11/955,588

(22) Filed: Dec. 13, 2007

(30) Foreign Application Priority Data
Dec. 14, 2006 (FI) 20065804

(51) Int. Cl. G06F 17/30

(52) U.S. Cl. 707/102; 707/E17.009

(57) ABSTRACT

A characterization system characterizes run-time properties of a computing system comprising hardware and software. The characterization system comprises generating means for generating an associative data structure comprising load data and priority data. The priority data characterize importance of a sub-process of a computer process during the execution of the computer process, and the load data characterize the use of resources of the computing system at an importance of the sub-process.

### FIELD

The invention relates to a method for characterizing run-time properties of a computing system comprising hardware and software. The invention further relates to a computer program and system implementing the method.

### BACKGROUND

Characterization and understanding of run-time properties of a processor system is required in order to optimize the performance of the processor system. The optimization may lead to improvement in the software and improved utilization of hardware, which may result in improved user perceived performance, lower performance requirement of the hardware and lower energy consumption in the processor system.

The characterization is, however, a challenging task due to the high complexity of the software being processed and the complexity of modern processor system.

Therefore, it is desirable to consider technical improvements related to the characterization of run-time properties of a processor system.

### BRIEF DESCRIPTION OF THE INVENTION

An object of the invention is to provide an improved method, system and computer program for characterizing run-time properties of a computing system. According to an aspect of the invention, there is provided a method for characterizing run-time properties of a computing system comprising hardware and software, the method comprising generating an associative data structure comprising load data and priority data by using process data collected from the computing system, wherein the priority data characterize importance of a sub-process of a computer process during the execution of the computer process and wherein the load data characterize the use of resources of the computing system at an importance of the sub-process.

According to another aspect of the invention, there is provided a system for characterizing run-time properties of a computing system comprising hardware and software, comprising generating means for generating an associative data structure comprising load data and priority data, wherein the priority data characterize importance of a sub-process of a computer process during the execution of the computer process and wherein the load data characterize the use of resources of the computing system at an importance of the sub-process.

The invention provides several advantages.

In an embodiment of the invention, the invention provides an associative data structure including priority data and load data associated with the priority data. The associative data structure may be used for generating a graphical presentation to be used by an analyst. The associative data structure may further provide data for an automated procedure, which assesses the efficiency of the use of the resources of the computing system.

### LIST OF DRAWINGS

In the following, the invention will be described in greater detail with reference to the embodiments and the accompanying drawings, in which

FIG. 1 shows an example of a computing system;

FIG. 2 shows a first example of a computing system and a characterization system;

FIG. 3 shows a second example of a computing system and a characterization system;

FIG. 4A shows a first example of the characterization system;

FIG. 4B shows a second example of the characterization system;

FIG. 5A shows an example of the time evolution of a computer process;

FIG. 5B shows a first example of a graphical presentation of the associative data structure;

FIG. 6 shows a second example of a graphical presentation of the associative data structure;

FIG. 7 shows a third example of a graphical presentation of the associative data structure; and

FIG. 8 shows an example of methodology according to an embodiment of the invention.

### DESCRIPTION OF EMBODIMENTS

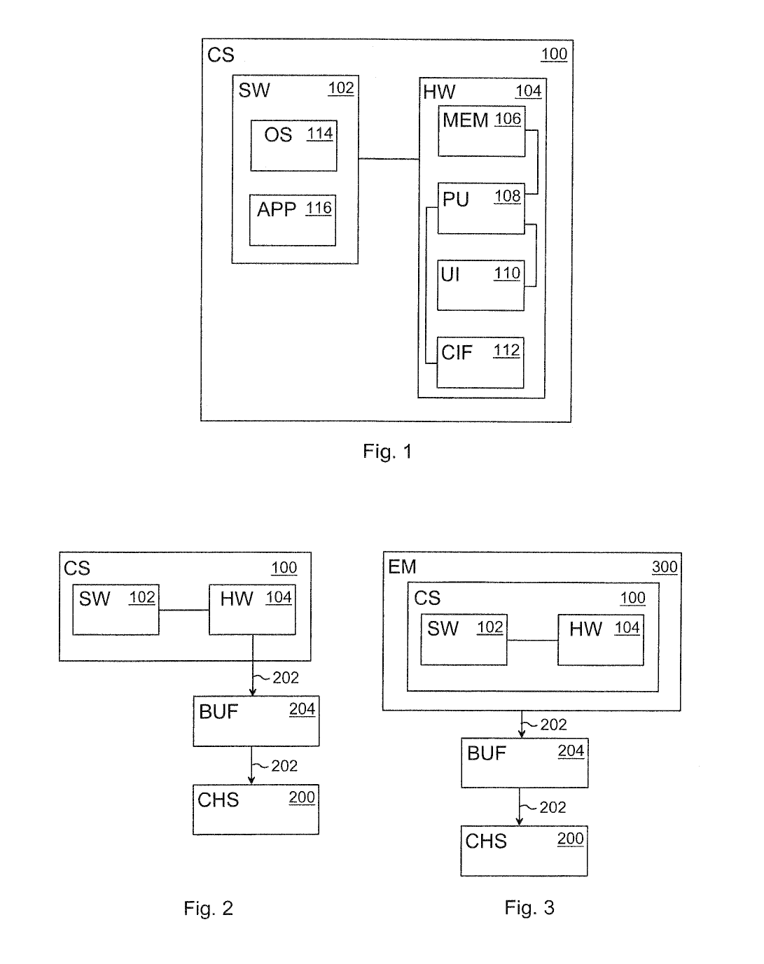

With reference to FIG. 1, examine an example of a computing system (CS) 100, in which embodiments of the invention can be applied. The computing system comprises software (SW) 102 and hardware (HW) 104.

The hardware 104 typically comprises digital processing means, such as a processing unit (PU) 108, memory means (MEM) 106, user interface (UI) 110 and communication interfaces (CIF) 112.

The software 102 typically comprises an operating system (OS) 114 and applications (APP) 116. The software 102 may be stored in the memory means 106 or loaded into the computing system 100 from a request.

The processing unit 108 typically comprises a digital processor, which executes a computer process encoded by the software. The processing unit 108 may further include a processor dedicated for a specific task, such as processing graphical data.

The memory means 106 may comprise processor memory located in the central processing unit 108, random access memory (RAM), read-only memory (ROM) and/or mass memory.

The user interface 110 typically comprises a display and an input device, such as a keyboard or a keypad.

The communication interface 112 is typically responsible for communication between the computing system and an external party, such as an access point of a telecommunication system. The communication interface 112 may implement a wireless interface, such as a telecommunication radio interface and/or a wireless local access network (WLAN).

In an embodiment of the invention, the communication interface 112 implements a short-range wireless interface, such as a BlueTooth and/or ZigBee interface.

In an embodiment of the invention, the communication interface 112 implements a wired communication interface.

In an embodiment of the invention, the computing system 100 is a wireless telecommunication device, such as a mobile phone.

In an embodiment of the invention, the computing system 100 is a personal computer or a laptop computer.

The invention is not, however, restricted to the given examples of a computing system 100, but may be applied to any computing system comprising software and hardware.

The computing system 100 executes computer processes comprising sub-processes. A sub-process may be one of the following: playing an audio and/or video file, running an interactive computer game, receiving and initializing voice phone calls, sending and receiving e-mails, text messages and/or multimedia messages, browsing web pages, down-/uploading files and streams of data over network connection, running office applications, capturing images, recording videos and/or audio files.

With reference to FIG. 2, the computing system 100 may be coupled to a characterization system (CHS) 200. The characterization system 200 receives process data 202, which characterizes the execution of a computer process in the computing system 100. The characterization system 100 characterizes run-time properties of the computing system 100 by using the process data 202 as input. A coupling between the computing system 100 and the characterization system 200 may be implemented with instrumentation to the hardware 104 and/or to the software 102.

In an embodiment, a buffer unit 204 is located between the computing system 100 and the characterization system 200. The buffer unit 204 acts as a gateway between the computing system 100 and the characterization system 200 and may include temporary and/or permanent memory means for storing the process data 202.

With reference to FIG. 1, hardware 104 may be instrumented by connecting the characterization system 200 physically to electric circuits of hardware 104, thus enabling direct measurements of any changes in the computing system 100 during the computer process.

For example, buses used for transferring processing data between physical components of hardware 104 may be instrumented and processing data associated with the computer process can be collected and stored using the characterization system 200. The instrumentation may be internal or external to the computing system. The external instrumentation may comprise cameras, magnetic sensors, temperature sensors and/or electron field activity sensors, for example.

The software 102 may be instrumented by placing instrumentation code comprising instrumentation instructions into the software 102. The instrumentation instructions may produce identifiable data records that describe the state of the computer process and the computing system 100. The data records may be stored in memory for later use, transferred from the computing system 100 via communication interface or displayed to user via the user interface 110.

The Instrumentation code may be inserted to a temporal neighbourhood of any interesting events of software instruction flow. This will lead to accurate measurements of any arbitrary events that can be defined in software source code level.

In another embodiment, the software is instrumented by creating a timed mechanism which triggers a specific measurement code to be run at pre-defined frequency, thus giving a statistical view of the state of the computing system 100. Timing can be based on an internal clock of the computing system 100 and software mechanisms connected to it, or on external timing.

In an embodiment, the software 102 may observe its internal behaviour and the hardware behaviour. The software 102 may store this information into permanent or temporarily storage. The software 102 may provide this information through the communication interface 112.

The process data 202 may include priority information related to the importance of the sub-processes, load information related to the load of the computing system, and resource information related to the available resources of the computing system.

The process data 202 may further include sharing of total load, as well as of resource usage, of each sub-process. Information specifying and identifying the general context of the computer process may also be included in the process data 202. This information may include description of computing system configuration, records of user interaction, information about temporal and spatial location of the computing system 100, the location of the computing system 100 in possible logical arrangement of several systems or other components.

Process data 202 may also include information about an intraprocess context. For example, the function name or memory address of current execution may be included, as well as a history path of execution flow inside a sub-process.

Records of inter-process communication may also be included in the process data 202.

The priority information may control the program scheduler of the computing system 100, which schedules the execution of a sub-process.

The load information characterizes the load of the hardware of the computing system. The load information may include a parameter specifying an instantaneous load or an averaged load over a time period. The load information may characterize the load of the processing unit 108. In an embodiment of the invention, the load information includes information on the usage of the memory means 106. The load information may further include, memory accesses, cache misses and/or bus utilization.

In general, load may also refer to utilization of, for example, communication interface, graphics processor, hard disk drive, or other peripherals and devices in the computing system 100. In addition to physical resources, load may also refer to logical resources and software components. For example, a device driver or file server component of software 102 may be utilized by other parts of software in a way that may be characterized as load.

The resource information may include, for example, the instantaneous clock frequency of the processing unit 108, the maximum storage capacity of the memory means 106, a memory allocated to the sub-process and/or measured or approximated power consumption.

The resource information may indicate the state of processors, such as active, idle, sleep, frequency of behaviour, voltage, cache hit rate and/or communication interconnect load.

With reference to FIG. 3, the operation of the computing system 100 may be emulated by an emulator 300. The emulator 300 is typically a computer system, which simulates the computer process according to the characteristics of the hardware 102 and the software 104. The emulator generates process data 202 which are provided into the characterization system 200.

In an embodiment of the invention, the characterization system 200 is integrated into the computing system 100 and/or the emulator 300. In such a case, the characterization system 100 may be implemented with a computer program executed in the processing unit 108.

The process data 202 may be obtained by sampling the computing system 100 and/or the emulator 300.

The sampling may be based on dynamically adjusted frequency which may be optimised during a sampling process.

In another embodiment, the sampling may be triggered by some events in the computer process. For example, a peripheral device usage might be registered every time as the device is being accessed. This approach may give more accurate information with lower overhead than frequent polling of device state and activity. The computing system's 100 scheduler may be instrumented to collect precise information about sub-processes and their execution whenever it is used.

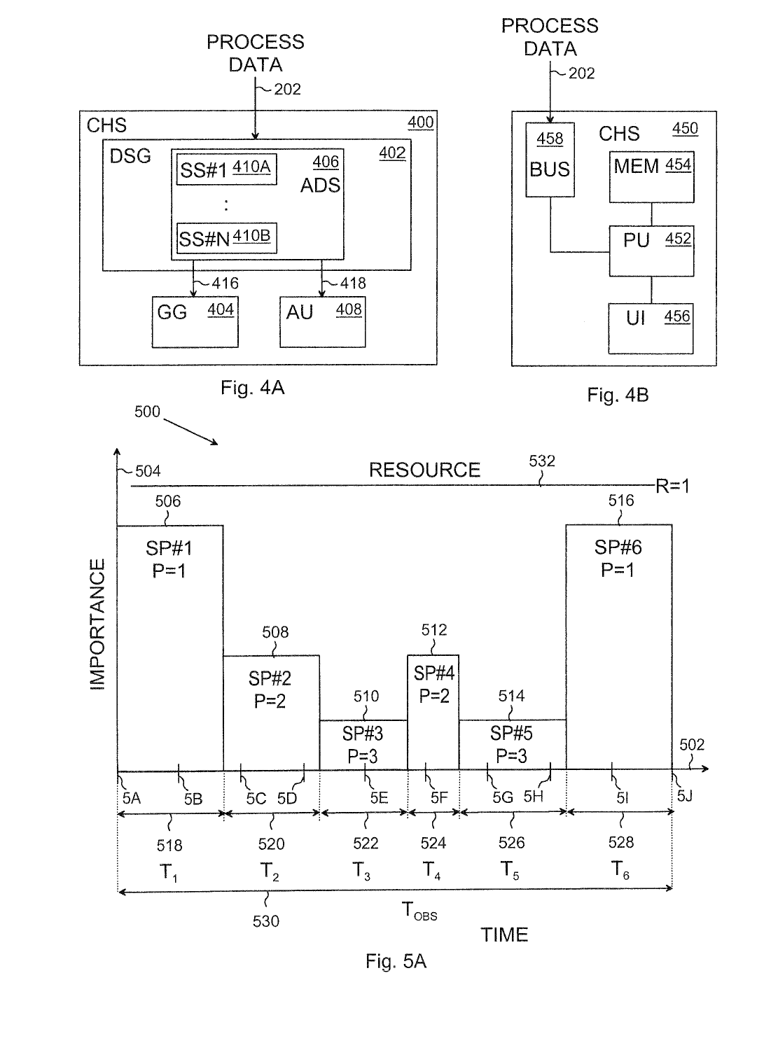

With reference to FIG. 4A, the characterization system 400 comprises a data structure generator (DSG) 402, which uses the process data 202 as input and generates an associative data structure (ADS) 406 by using the process data 202. The characterization system 400 may further comprise a graphical generator 404, which generates graphical presentation of the associative data structure 406 according to an input 416 from the data structure generator 402.

With reference to FIG. 4B, the characterization system 450 may be implemented with a processing unit (PU) 452 and a computer program stored in a memory unit (MEM) 454. The characterization system 450 may further include bus means (BUS) 458, such as a serial or parallel bus, for connecting to the computing system 100. The characterization system 450 may further include a user interface (UI) 456, such as a display and a keyboard.

The data structure generator 406 may be implemented with a computer program executed in the processing unit 452 and stored in the memory unit 454.

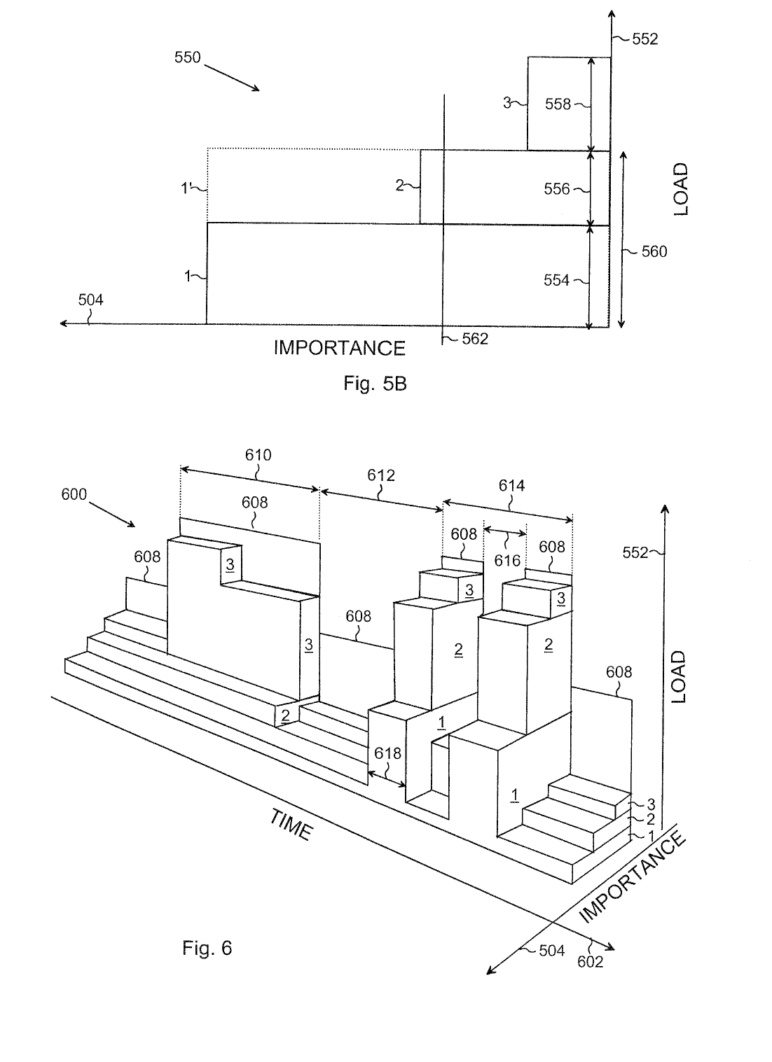

With reference to FIG. 5A a graphical presentation 500 during an observation period 530 of a computer process is shown. The vertical axis 504 and the horizontal axis 502 represent importance of a sub-process and time, respectively. The importance may be presented with a unitless integer, while the time is presented in time units, such as milliseconds.

FIG. 5A further shows resource information 532, such as the clock frequency of the processing unit 108.

In an embodiment, the resource information 532 includes relative performance level, which may depend on clock speed and/or sleep and power switching modes.

In the example of FIG. 5A, the resource information R=1 indicates the use of full resources. If the clock frequency were half of the maximum frequency, the resource information 532 would indicate R=0.5.

FIG. 5A shows sub-processes SP#1 506, SP#2 508, SP#3 510, SP#4 512, SP#5 514 and SP#6 516 with priority parameters P=1, P=2, P=3, P=2, P=3 and P=1, and durations (T₁) 518, (T₂) 520, (T₃) 522, (T₄) 524, (T₅) 526 and (T₆) 528, respectively. A sub-process 506 to 516 with low priority parameter P is of high importance and vice versa.

FIG. 5A also shows sample points 5A, 5B, 5C, 5D, 5E, 5F, 5G, 5H, and 51. Each sample point 5A to 51 is associated with a time instant and importance of the sub-process 506 to 516.

The load associated with each sub-process 506 to 516 may be obtained from the duration 518 to 528 of the sub-process 506 to 516 relative to the duration 530 of the observation period 530. For example, the load associated with ith sub-process SP#i may be obtained from equation

$${L}_{i} = ( \frac{{T}_{i}}{{T}_{OBS}} ) \times {L}_{OBS} , \qquad ( 1 )$$

where Tᵢ indicates the duration of sub-process SP#1, and LOBS indicates the load during the observation period 530. In an embodiment, LOBS equals unity, and load Lᵢ is expressed with relative load.

In an embodiment of the invention, the process data 202 is collected at the sample points 5A to 51. Thus, the importance represents the priority information, and the durations 518 to 528 represent the load information.

In an embodiment of the invention, the process data 202 is subjected to a statistical analysis. The statistical analysis may include determination of load at each importance during the observation period 530. The statistical analysis may result in the following associative data structure:

| Time | Importance | Load | Resource |
|---|---|---|---|
| Tₛₜₐᵣₜ | 1 | T₁ + T₆ | 1 |
| | 2 | T₂ + T₄ | 1 |
| T_{end} | 3 | T₃ + T₅ | 1 |

Tₛₜₐᵣₜ and T_{end} indicate the starting moment and the ending moment, respectively, of the observation period 530. Column “Importance” includes priority data elements of the priority data characterizing the importance of the sub-process indicated with the priority parameters. Column “Load” includes load data elements of the load data. A load data element at given priority data element is obtained from the sum of durations associated with a common priority parameter. Column “resource” represents the resource data characterizing the maximum available resources of the computing system 100.

The statistical analysis may be carried out in the data structure generator 402.

The priority data elements characterize importance of a sub-process of the computer process during the execution of the computer process.

Each load data element characterizes the use of resources of the computing system 100 at an importance of the sub-process.

The table above shows an example of a sub-structure of the associative data structure 406 of FIG. 4A. The associative data structure 406 may in general include N>1 sub-data structures 410A, 410B (SS#1,SS#N), which are generated by the data structure generator 402.

The associative data structure 406 comprises binding between a load data element and an associated priority data element. The binding may be implemented by indexing the load data element and the associated priority data element with a common index. The common indexing may also be applied to resource data elements. In addition to common indices, binding may also be determined based on temporal correspondence.

In an embodiment of the invention, the characterization system further comprises a graphics generator (GG) for generating a graphical presentation by using the associative data structure 406.

Examples of graphical presentations are shown in FIG. 5B, 6 and 7.

In FIG. 5B, the graphical presentation 550 corresponding to the observation period 530 of FIG. 5A is shown. The horizontal axis 504 and the vertical axis 552 represent importance of a sub-process and load at given importance, respectively. In an embodiment of the invention, the graphical presentation is orthogonal, where the load data and priority data are illustrated orthogonally.

In this example, the portions 1, 2 and 3 may be classified into categories “IMPORTANT”, “NORMAL” and “LOW”, respectively. The relative loads 554, 556 and 558 may be obtained from the table above.

The illustration of graphical presentation 550 may give insight to what kind of load the computing system processes during the observation period 530. The area of each portion 1, 2, 3 indicates the amount of resources, i.e. load, allocated for each priority.

With reference to FIG. 6 an orthogonal graphical presentation 600 may include time information. The graphical presentation 600 includes a time axis 602, a load axis 552 and an importance axis 504.

The graphical presentation 600 includes categories 1, 2 and 3. In the time dimension, the graphical presentation 600 is composed of sub-presentations 618, which correspond to the graphical presentation 550 of FIG. 550. Each sub-presentation corresponds to a sub-data structure 410A, 410B of the associative data structure 406.

The graphical presentation further shows the resource data 608, such as that characterizing the clock frequency of the processing unit 108. For example, during time interval 610, the maximum resources available are approximatively twice those available at time interval 612.

During time interval 610, there is relatively high load at low importance. However, the resource data 608 indicates that the maximum resources available are relatively high. This indicates that the computing system allocates excessive resources for sub-processes with low importance.

During time interval 614, there are two short time periods where the resource data indicates high maximum resources available. Between the two periods there is a short period 616, during which low maximum resources are available. If there is a high penalty related to switching the state of the computing system between the high and low maximum resources available, the analyst may deduce from the graphical presentation that the cause for the change of the state is to be removed.

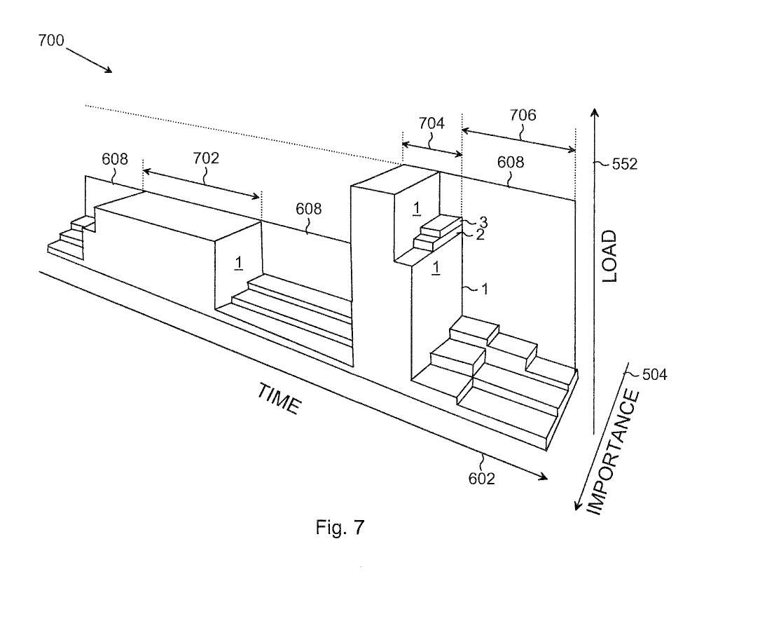

With reference to FIG. 7, more examples of the graphical presentation 700 for the analysis are shown.

During time interval 702, sub-processes with high importance are computed using only half of the maximum capacity. This observation may indicate that the computing system does not operate properly. Such a situation may be caused by an error in the software 102 or a bottleneck situation, when something blocks the important processes from proceeding or causes it to do excess work, thus blocking everything else. Also, there is possibility that the computing system 100 does not recognize need for higher computing capacity.

During time interval 704, the importance of the sub-processes is high, but the duration of the computer process is relatively long. The resource data 608 indicates that the entire resources are used for the process. The combination of these observations indicates existence of a bottleneck due to a deficiency in the software 102 and/or the hardware 104.

During time interval 706, the load suddenly drops, but the resource data 608 indicates high maximum resources available. In this case, the maximum resources available would be decreased for saving battery, for example. The examples of FIGS. 5B, 6 and 7 illustrate the importance of the graphical presentation when the assessment of the deficiencies of the computing system 100 is carried out by an analyst.

The graphical generator 404 may be implemented as a computer program executed in the processing unit 452 and stored in the memory unit 452. The graphical generator 404 may include a graphics controller, such as a graphics card of a PC.

In an embodiment of the invention, the characterization system 100 further comprises an assessing unit (AU) 408 for assessing the efficiency of the use of the resources of the computing system 100 on the basis of the contents 418 of the associative data structure 406.

In an embodiment of the invention, the assessing unit 408 decreases the number of importance categories. In a simple case, the number of the importance categories is two. The two categories would be “IMPORTANT” and “NON-IMPORTANT”, for example.

FIG. 5B shows a situation where portions 1 and 2 are represented by a common category 1′, while portion 3 remains. In this case, portion 1′ would be “IMPORTANT” and portion 3 “NON-IMPORTANT”. The sub-processes with importance “IMPORTANT” are executed at load 560, while sub-processes with importance “NON-IMPORTANT” are executed at load 558.

In a general case, the division between the two categories may be defined by an importance limit 562. Sub-processes having importance more than indicated by the importance limit 562 may be included in category “IMPORTANT”, while sub-processes having importance less than indicated by the importance limit 562 may be included in category “NON-IMPORTANT”.

In an embodiment of the invention, the assessing unit 408 calculates a ratio of the load data elements of the two categories. Let is denote the load data element at importance “IMPORTANT” L_{I} and load element at importance “NON-IMPORTANT” L_{NI}. The following assessments may be done:

$$\frac{{L}_{I}}{{L}_{N I}} > {L}_{max} \text{:} system overload$$

$$\frac{{L}_{I}}{{L}_{N I}} < {L}_{min} \text{:} waste of resources$$

$${L}_{min} < \frac{{L}_{I}}{{L}_{N I}} < {L}_{max} \text{:} a cceptable efficiency of use of resources$$

In the Lₘₐₓ and Lₘᵢₙ are threshold values, which may have been determined empirically.

It should be noted that the mathematical expressions and especially the ratio between load values are examples only, and a person skilled in the art may use any comparing method between the load values by using teachings given above.

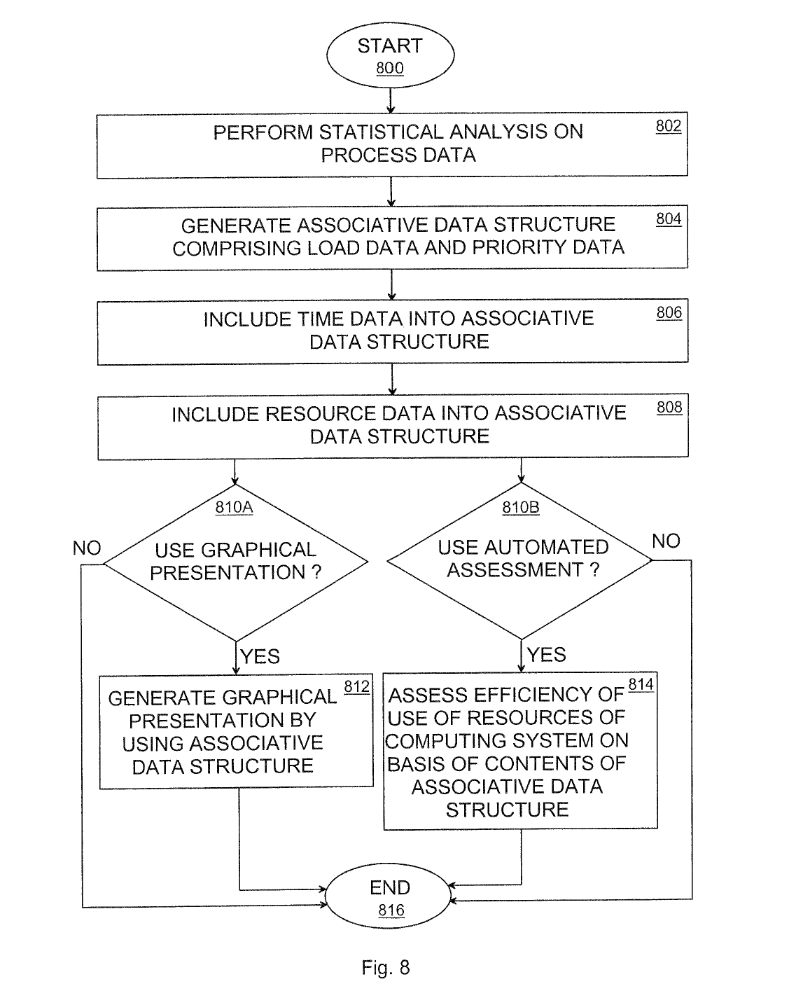

With reference to FIG. 8, methodology according to embodiments of the invention is illustrated with a flow chart.

In 800, the method starts.

In 802, according to an embodiment, a statistical analysis on the process data comprising priority information and load information is performed.

In 804, an associative data structure 406 comprising load data and priority data is generated by using process data 202 collected from the computing system 100, wherein the priority data characterize importance of a sub-process of a computer process during the execution of the computer process and wherein the load data characterize the use of resources of the computing system 100 at an importance of the sub-process. In an embodiment of the invention, the associative data structure 406 is generated according to the statistical analysis.

In 806, time data are included into the associative data structure 406, wherein the time data are associated with the load data and the priority data.

In 808, resource data obtained from the process data 202 are included into the associative data structure 406, the resource data characterizing the maximum available resources of the computing system 100.

In 810A, the method is divided into two options. If the associative data structure is presented graphically, a graphical presentation is generated by using the associative data structure 406 in 812. In an embodiment of the invention, the graphical presentation comprises an orthogonal presentation of the load data and the priority data. Further, in an embodiment, the graphical presentation comprises an orthogonal presentation of time with respect to the load data and the priority data.

In 810B, the method is divided into two options. If the assessment is being automated, the efficiency of the use of the resources of the computing system 100 is assessed on the basis of the contents of the associative data structure 406 in 814.

In 816, the method ends.

The flow chart of FIG. 8 also illustrates a computer process according to the embodiments of the invention.

The computer process may be encoded by a computer program of instructions. The computer program may be executed in the processing unit 452 and stored in the memory unit 454 of the characterization system 100.

The computer program may be embodied on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method for characterizing run-time properties of a computing system comprising hardware and software, the method comprising:
generating an associative data structure comprising load data and priority data by using process data collected from the computing system, wherein the priority data characterize importance of a sub-process of a computer process during the execution of the computer process and wherein the load data characterize the use of resources of the computing system at an importance of the sub-process.

2. The method of claim 1, further comprising including time data into the associative data structure, wherein the time data are associated with the load data and the priority data.

3. The method of claim 1, further comprising including resource data obtained from the process data into the associative data structure, the resource data characterizing the maximum available resources of the computing system.

4. The method of claim 1, further comprising:
performing a statistical analysis on the process data comprising priority information and load information; and
generating the associative data structure according to the statistical analysis.

5. The method of claim 1, further comprising generating a graphical presentation by using the associative data structure.

6. The method of claim 5, wherein the graphical presentation comprises an orthogonal presentation of the load data and the priority data.

7. The method of claim 5, wherein the graphical presentation further comprises an orthogonal presentation of time with respect to the load data and the priority data.

8. The method of claim 1, further comprising assessing the efficiency of the use of the resources of the computing system on the basis of the contents of the associative data structure.

9. A computer program embodied on a computer program distribution medium readable by a computer and encoding a computer program of instructions for executing a computer process for characterizing run-time properties of a computing system comprising hardware and software, the process comprising:
generating an associative data structure comprising load data and priority data by using process data collected from the computing system, wherein the priority data characterize importance of a sub-process of a computer process during the execution of the computer process and wherein the load data characterize the use of resources of the computing system at an importance of the sub-process.

10. A system for characterizing run-time properties of a computing system comprising hardware and software, wherein the system comprises generating means for generating an associative data structure comprising load data and priority data, wherein the priority data characterize importance of a sub-process of a computer process during the execution of the computer process and wherein the load data characterize the use of resources of the computing system at an importance of the sub-process.

11. The system of claim 10, wherein the generating means is configured to include time data into the associative data structure, wherein the time data are associated with the load data and the priority data.

12. The system of claim 10, wherein the generating means is configured to include resource data into the associative data structure, the resource data characterizing the maximum available resources of the computing system.

13. The system of claim 10, wherein the generating means is configured to perform a statistical analysis on the process data comprising priority information and load information; and
wherein the generating means is configured to generate the associative data structure according to the statistical analysis.

14. The system of claim 10, further comprising graphical generating means coupled with the generating means, for generating a graphical presentation by using the associative data structure.

15. The system of claim 14, wherein the graphical generating means is configured to generate the graphical presentation, which comprises an orthogonal presentation of the load data and the priority data.

16. The system of claim 14, wherein the graphical generating means is configured to generate the graphical presentation, which comprises an orthogonal presentation of time with respect to the load data and the priority data.

17. The system of claim 10, further comprising an assessing means for assessing the efficiency of the use of the resources of the computing system on the basis of the contents of the associative data structure.
